(19) United States
(12) Patent Application Publication
(10) Pub. No.: US 2014/0079370 A1
(43) Pub. Date: Mar. 20, 2014

(54) DIGITAL VIDEO CONVERTER AND METHOD FOR READING AND WRITING VIDEO STREAM

(71) Applicant: ALI (ZHUHAI) CORPORATION, Guangdong (CN)

(72) Inventor: Jiang Qian, Guangdong (CN)

(73) Assignee: ALi (Zhuhai) Corporation, Guangdong (CN)

(21) Appl. No.: 13/707,411

(22) Filed: Dec. 6, 2012

(30) Foreign Application Priority Data
Sep. 14, 2012 (CN) 201210343149.0

(51) Int. Cl. H04N 5/76; H04N 5/775

(52) U.S. Cl. CPC H04N 5/76; H04N 5/775
USPC 386/230; 386/326

(57) ABSTRACT

A digital video converter and a method for reading and writing a video stream are provided. The digital video converter includes a processing device and a storage device. The processing device runs an operating system, wherein the operating system is configured with a kernel and a user space. The storage device is coupled to the processing device and stores data. The processing device performs data read and write operations to the storage device through the kernel, where the data read and write operations performed to the storage device by the kernel do not involve the user space.

### CROSS-REFERENCE TO RELATED APPLICATION

This application claims the priority benefit of China application serial no. 201210343149.0, filed on Sep. 14, 2012. The entirety of the above-mentioned patent application is hereby incorporated by reference herein and made a part of this specification.

### BACKGROUND

1. Technical Field

The invention relates to a data read and write technique of a digital video converter. Particularly, the invention relates to a digital video converter and a method for reading and writing a video stream.

2. Related Art

A hard disk and a processor are two indispensable components in a computer system. The hard disk is used to store data, and the processor controls the hard disk through a file system run in an operating system, and reads data from or writes data into the hard disk. The commonly used file systems are, for example, a file allocation table (FAT) file system, a high performance file system (HPFS), a new technology file system (NTFS) and other types of file system. Presently, the NTFS has gradually replaces the FAT file system and the HPFS, and the NTFS is a main file system standard used in a Windows NT operating system and later released operating systems of the Microsoft Corporation.

As many data read and write techniques are provided by the Microsoft Corporation and protected by related intellectual property laws, and due to a difference in data structures, most of the non-Microsoft operating systems (for example, a Unix operating system or a Unix-like operating system) cannot effectively support the NTFS. For example, the Linux operating system can only read data from the hard disk through the NTFS, and cannot write data into the hard disk through the NTFS. In order to maintain a basic support (for example, capable of executing basic data read and write operations) of the Linux operating system for the NTFS, the Linux operating system has to additional run a filesystem in userspace (FUSE), for example, an NTFS file system driving program (for example, NTFS-3G).

In broad terms, the FUSE file system refers to a file system completely implemented in a user mode or a user space, through which a user can view information such as a file name and a file storage path, etc. stored in the file system, and can modify, copy, and access the file. Therefore, many non-Microsoft operating systems take the FUSE as a core and as a used file system module. However, the FUSE file system still has may restrictions and inconveniences in operation, for example, when a file stored in the hard disk is moved or read/written, the operating system frequently performs operation such as copying and changing file attributes, etc. between a kernel and the user space, which may cause a problem that the operating system has a poor data read and write speed on the hard disk. For example, each file in the FUSE file system is assigned with an index code (which is referred to as Mode in abbreviation), and such Mode is located in the user space. When such file is moved or read/written, the Mode corresponding to such file is also correspondingly modified, which increases a file moving time, and causes delay of the operating system.

FIG. 1 is a schematic diagram of data read and write operations performed in the FUSE file system. Referring to FIG. 1, it is assumed that when a user wants to write a file 101 into a file storage path (for example, “C: \A\” of a hard disk C), a kernel 11 of the operating system first obtains the file 101 from a data access interface, and temporarily stores the file 101 in a buffer 102 (step S110). Then, the kernel 11 copies the file 101 from the buffer 102 to a user space 12 by using a function “copy to user”, and meanwhile modifies an Mode 104 corresponding to the file 101 and presents the modified file storage path (“C: \A\”) for the user to inspect (step S120). Then, the kernel 11 copies the file 101 from the user space 12 to another buffer 103 by using a function “copy_from_user” (step S130), and writes the file 101 into the hard disk 13 (i.e. the hard disk C) or a related memory (step S140) to complete the write operation of the file 101.

In the process of writing the file 101 into the hard disk 13, the operating system executes the operations of file copy and Mode modifying, etc. for at least twice. Similarly, when data is read or moved from the hard disk, the current FUSE file system at least performs the copy operation between the kernel and the user space for more than twice, which decreases a read and write efficiency of data.

Particularly, regarding a digital video converter capable of recording or playing videos in real-time, especially a digital television (TV) set-top box (STB) capable of recording or playing signals of a high definition television (HDTV), any slight delay may cause severe error in image frames or sounds. Therefore, how to improve a file read and write speed of the digital video converter is an important problem to be resolved.

### SUMMARY

The invention is directed to a digital video converter and a method for reading and writing a video stream, by which read and write of the video stream in a storage device is implemented without involving a user space, so as to improve a speed that an operating system reads and writes data from/into the storage device.

The invention provides a digital video converter including a processing device and a storage device. The processing device runs an operating system, where the operating system is configured with a kernel and a user space. The storage device is coupled to the processing device and is used to store data. The processing device executes a writing process to write a video stream to the storage device according to a data storage request of a user. When the writing process is executed, the kernel obtains a specified identifier corresponding to a specified storage space in the storage device according to the data storage request of the user, and writes the video stream into the specified storage space according to the specified identifier. Moreover, the processing device executes a reading process to read the video stream from the storage device according a data reading request of the user, and when the reading process is executed, the kernel obtains the specified identifier corresponding to the specified storage space storing the video stream, searches the specified storage space according to the specified identifier, and reads the video stream from the specified storage space, where the writing process and the reading process do not involve the user space.

In an embodiment of the invention, the kernel inquires a logical block address (LBA) table to obtain a logical address corresponding to the specified storage space, where the LBA table indicates that the specified storage space corresponding to the logical address is capable of being written with data. Moreover, the kernel obtains the specified identifier corresponding to the specified storage space according to the logical address, searches the specified storage space according to the specified identifier, and writes the video stream into the specified storage space.

In an embodiment of the invention, the kernel inquires an LBA table to obtain a logical address corresponding to the specified storage space, where the LBA table indicates that the video stream has been written into the specified storage space corresponding to the logical address. Moreover, the kernel obtains the specified identifier corresponding to the specified storage space according to the logical address, searches the specified storage space according to the specified identifier, and reads the video stream from the specified storage space.

In an embodiment of the invention, the digital video converter further includes a video stream receiving device. The video stream receiving device is coupled to the processing device, and generates the video stream according to a television (TV) signal.

In an embodiment of the invention, the processing device displays a user operation interface in a display device, where the user operation interface displays a video file name corresponding to the video stream. Moreover, the processing device determines whether the video file name is selected, and when the video file name is selected, the processing device executes the reading process to play the video stream.

The invention also provides a method for reading and writing a video stream, which is adapted to a digital video converter, where the digital video converter includes an operating system and a storage device having a plurality of storage spaces, the operating system is configured with a kernel and a user space, and the method for reading and writing the video stream includes following steps. A writing process is executed to write a video stream to the storage device of the digital video converter according to a data storage request of a user, where the writing process includes following steps. The kernel obtains a specified identifier corresponding to a specified storage space in the storage device according to the data storage request of the user.

The kernel writes the video stream into the specified storage space according to the specified identifier. A reading process is executed to read the video stream from the storage device according a data reading request of the user, where the reading process includes following steps. The kernel obtains the specified identifier corresponding to the specified storage space storing the video stream. The kernel searches the specified storage space according to the specified identifier, and reads the video stream from the specified storage space, where the writing process and the reading process do not involve the user space.

In an embodiment of the invention, the writing process includes following steps. The kernel inquires a logical block address (LBA) table to obtain a logical address corresponding to the specified storage space, where the LBA table indicates that the specified storage space corresponding to the logical address is capable of being written with data. The kernel obtains the specified identifier corresponding to the specified storage space according to the logical address. The kernel searches the specified storage space according to the specified identifier, and writes the video stream into the specified storage space.

In an embodiment of the invention, the reading process includes following steps. The kernel inquires an LBA table to obtain a logical address corresponding to the specified storage space, where the LBA table indicates that the video stream has been written into the specified storage space corresponding to the logical address. The kernel obtains the specified identifier corresponding to the specified storage space according to the logical address. The kernel searches the specified storage space according to the specified identifier, and reads the video stream from the specified storage space.

In an embodiment of the invention, the video stream is obtained through a TV signal.

In an embodiment of the invention, the method for reading and writing the video stream further includes following steps. A user operation interface is displayed. A video file name corresponding to the video stream is displayed on the user operation interface. It is determined whether the video file name is selected, and when the video file name is selected, the reading process is executed to play the video stream.

According to the above descriptions, the invention provides the digital video converter and the method for reading and writing a video stream, by which read and write operations of the video stream in the storage device is implemented without involving the user space. In this way, a whole read and write speed of the video stream is effectively promoted to avoid occurrence of delay to influence a play quality.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of data read and write operations performed in a FUSE file system.

FIG. 2 is a block diagram of a digital video converter 20 according to an embodiment of the invention.

FIG. 3 is a block schematic diagram of data read and write operations performed by an operating system 220 according to an embodiment of the invention.

FIG. 4 is a schematic diagram of a writing process of the operating system according to an embodiment of the invention.

FIG. 5 is a flowchart illustrating a method for reading and writing a video stream according to an embodiment of the invention.

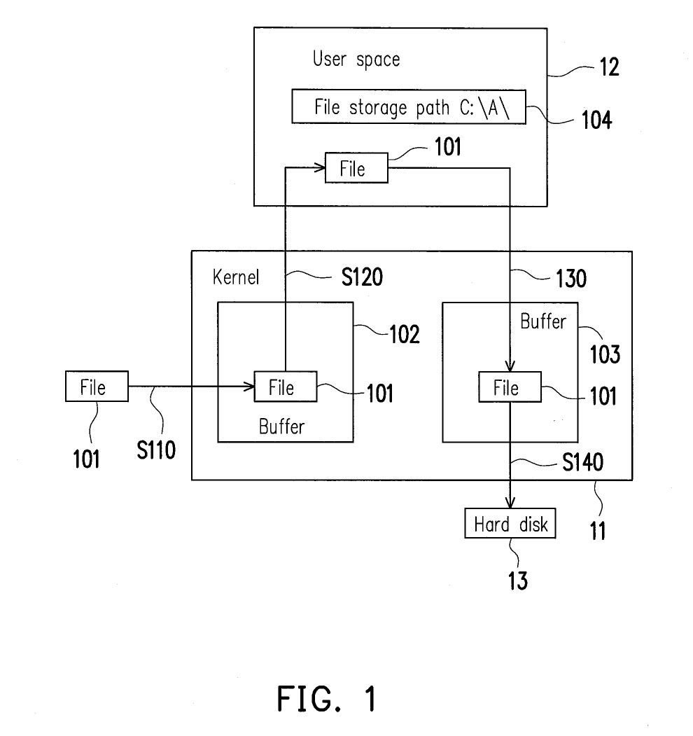

### DETAILED DESCRIPTION OF DISCLOSED EMBODIMENTS

In order to avoid repeat copy operations performed between a kernel and a user space of an operating system when a digital video converter (for example, a digital television (TV) set-top box (STB) reads or writes a video stream transmitted in real-time, an embodiment of the invention provides a digital video converter and a method for reading and writing a video stream, by which in case that the user space in the operating system is not involved, the kernel is directly used to read and write data in a storage device (for example, a hard disk). In this way, the performance that the digital video converter performs the read or write operation on the video stream can be effectively enhanced. In order to fully convey the spirit of the invention to those skilled in the art, embodiments are provided below for detailed descriptions.

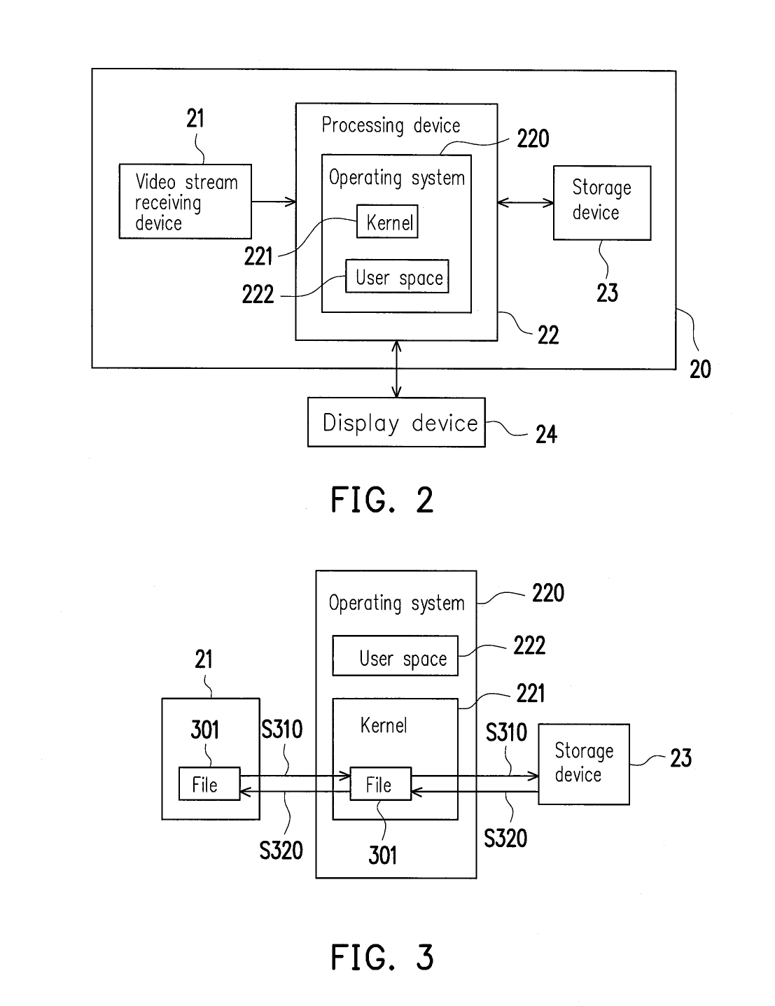

FIG. 2 is a block diagram of the digital video converter 20 according to an embodiment of the invention. Referring to FIG. 2, the digital video converter 20 includes a video stream receiving device 21, a processing device 22 and a storage device 23. Moreover, the digital video converter 20 is generally connected to a display device 24. A user can control the digital video converter 22 through a user operation interface displayed on the display device 24. The digital video converter 20 and the display device 24 can also be combined as a digital television (TV), which is complied with another implementation of the invention.

The video stream receiving device 21 generates a video stream according to a digital TV signal. For example, the video stream receiving device 21 can receive wireless TV signals through a wireless manner by using an antenna or a radio frequency (RF) receiving circuit, etc., and convert the received wireless TV signals into the video stream of a digital-form. For another example, the digital video converter 20 can receive video streams from the Internet or a cable TV provider through a network interface card or a video signal input interface, etc. Alternatively, the video stream receiving device 21 may have both of the aforementioned devices, such that the digital video converter 20 can receive and play wireless TV signals and cable TV signals, which is not limited by the invention.

The processing device 22 is coupled to the video stream receiving device 21, which is mainly used to run an operating system 220, where the operating system 220 is configured with a kernel 221 and a user space 222. In the present embodiment, the processing device 22 is, for example, a central processing unit (CPU), a microprocessor or an embedded processor, though the invention is not limited thereto. Moreover, the processing device 22 can also be configured with a temporary memory used in related operations of the operating system. The operating system 220 can be a Unix operating system or a Unix-like operating system. The Unix-like operating system is, for example, FreeBSD, OpenBSD, Solaris, Minix, Linux, QNX or other operating systems obtained by ameliorating the aforementioned known operating system and used for specific equipment, which is not limited by the invention.

The kernel 221 is a basic part of the operating system 220, which is mainly used to manage a system resource, and the user space 222 is controlled by the operating system. In other words, the operating system configures a virtual memory in the temporary memory of the storage device 23 or the processing device 22, and divides the virtual memory into the user space 222 and a kernel space for the kernel 221. Driving programs of the kernel 221 and the digital video converter 20 and expansion programs extended from the kernel 221 are run in the kernel space. Moreover, virtual memory spaces required by other application programs are configured in the user space 222. Particularly, index codes (inodes), etc. required when the user accesses data are also configured in the user space 222. However, when the digital video converter 20 of the present embodiment reads and writes data, the user space 222 is not involved, which is described in detail below.

The storage device 23 is coupled to the processing device 22, and is used to store data such as video streams, etc. In the present embodiment, the storage device 23 can be various non-volatile memories or combinations thereof, for example, a read-only memory (ROM) and/or a flash memory, where the ROM is, for example, a programmable read-only memory (PROM), an electrically alterable read-only memory (EAROM), an erasable programmable read-only memory (EPROM) and/or an electrically erasable programmable read-only memory (EEPROM). Moreover, the storage device 23 may also include a hard disk, an optical disc or an external storage device (for example, a memory card, a flash drive, etc.) or combinations thereof, and implementation of the storage device 23 is not limited by the invention.

In detail, the operating system 220 of the processing device 22 uses the kernel 221 to access data stored in the storage device 23, for example, in a recording mode of the digital video converter 20, the kernel 221 can directly write the video stream received by the video stream receiving device 21 into the storage device 23, or in a play mode of the digital video converter 20, the kernel 221 can directly replay the video stream previously recorded or stored in the storage device 23. Particularly, the spirit of the embodiment lies in that the data read and write operations performed to the storage device 23 by the kernel 221 do not involve the user space 222. Such feature results in an essential difference between the digital video converter 20 of the invention and the digital video converter of filesystem in userspace (FUSE) structured on the user space.

Since the digital video converter 20 is only used to execute a play operation and a recording operation of the video stream, the user only needs to know basic information such as the stored videos in the digital video converter 20 or the available storage space in the digital video converter 20. Therefore, in the present embodiment, the digital video converter 20 actually does not need to create a complex and complete data folder structure as that does of a computer system. Comparatively, the digital video converter 20 complied with the spirit of the present embodiment only needs an ameliorated file system structure capable of supporting basic operation functions of quick accessing the video streams or other files, etc. Namely, the digital video converter 20 directly reads and writes the video stream from/to the storage device 23 without modifying any setting in the user space 222, and the accessed data can be read and written from/to the storage device 23 without using the user space 222.

In the present embodiment, the display device 24 can be a general display screen, and is capable of receiving an input signal from a remote controller, a mouse or a physical button. Alternatively, the display device 24 can be a touch screen of any type, which is capable of detecting a touch operation on a surface thereof to generate a touch signal, where the touch screen may include a resistive touch panel, a capacitive touch panel, an optical touch panel, an acoustic wave touch panel, an electromagnetic touch panel, etc., which is not limited by the invention.

FIG. 3 is a block schematic diagram of data read and write operations performed by the operating system 220 according to an embodiment of the invention. Referring to FIG. 3, when the kernel 221 wants to write a file 301 to the storage device 23, the kernel 221 takes the aforementioned virtual memory as a buffer, and directly writes the file 301 into a corresponding storage region of the storage device 23 (step S310). Moreover, when the kernel 221 wants to read the file 301 from the storage device 23, the kernel 221 can directly obtains the required file 301 from the corresponding storage region of the storage device 23 through the buffer (step S320) without repeatedly copying or transmitting the file 301 between the kernel 221 and the user space 222. In this way, when the video stream (for example, the file 301) is played or recorded, the operation system and the kernel of the present embodiment can effectively enhance a whole speed that the processing device 22 reads and writes the video stream or data stored in the storage device 23, so as to avoid occurrence of delay to influence a play quality.

Referring to FIG. 2 again, in the present embodiment, the operating system 220 of the processing device 22 can also execute a writing process to write a video stream of the video stream receiving device 21 to the storage device 23 according to a data storage request of a user. For example, the operating system 220 of the processing device 22 can receive the data storage request from the user through a remote controller, a mouse, a physical button and/or a touch screen, etc. In detail, when the operating system 220 executes the writing process according to the data storage request of the user, the kernel 221 first obtains a specified identifier corresponding to one or a plurality of specified storage spaces (the number of the specified storage spaces is determined by a file magnitude of the video stream) in the storage device 23 according to the data storage request of the user. Then, the kernel writes the video stream into the specified storage space according to the specified identifier.

For example, if the storage device 23 is a hard disk, a sector can be taken as a unit of the storage space to implement the aforementioned specified storage space. In this way, the aforementioned specified identifier is, for example, a sector header of each sector in the hard disk, and the sector header includes 3 digital types respectively representing a track, a cylinder and the sector. In other words, the aforementioned specified storage space and the specified identifier are correspondingly implemented according to a type of the storage device 23, which is not limited by the invention.

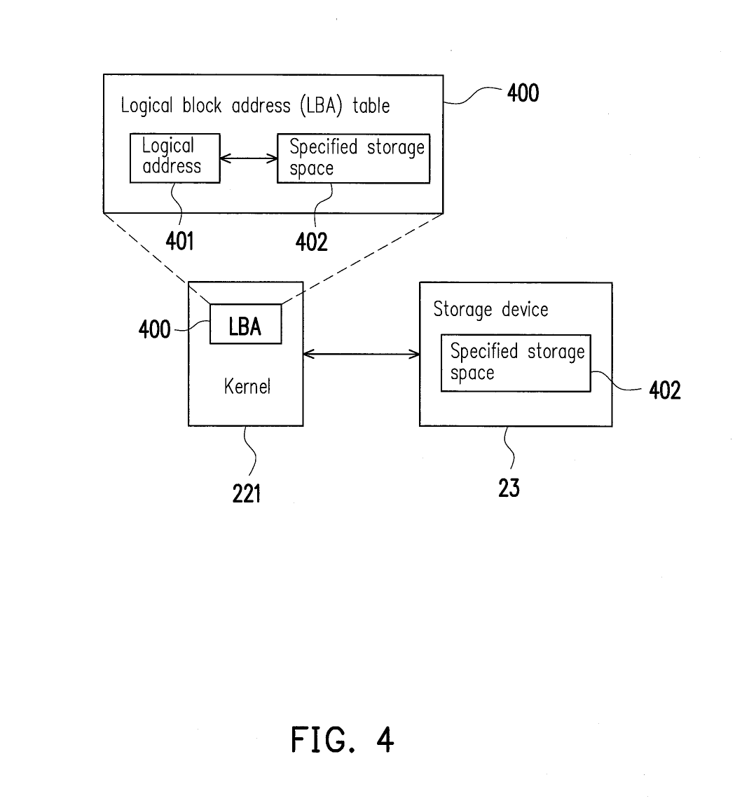

FIG. 4 is a schematic diagram of the writing process of the operating system according to an embodiment of the invention. Referring to FIG. 4, in the writing process of the video stream, the kernel 221 inquires a logical block address (LBA) table 400 to obtain a logical address 401 corresponding to a specified storage space 402 in the storage device 23. It should be noticed that the LBA table 400 indicates that the specified storage space 402 corresponding to the logical address 401 can be written with data. Then, the kernel 221 obtains the specified identifier corresponding to the specified storage space 402 according to the obtained logical address 401 and by looking up a table, and searches the specified storage space 402 in the storage device 23 according to the specified identifier, and writes the video stream into the specified storage space 402 after finding the specified storage space 402. In this way, in case that the user space is not involved, the kernel 221 can quickly write the video stream to the storage device 23.

Referring to FIG. 2 again, the processing device 22 executes a reading process to read the stored video stream from the storage device 23 according a data reading request of the user. For example, the operating system 220 of the processing device 22 can receive the data reading request of the user through a remote controller, a mouse, a physical button and/or a touch screen, etc. In detail, when the operating system 220 of the processing device 22 executes the reading process according to the aforementioned data reading request of the user, the kernel 221 obtains the specified identifier corresponding to the video stream to be played by the user, and searches the specified storage space in the storage device 23 that stores the video stream according to the specified identifier, and reads the video stream from the specified storage space for playing.

For example, similar to the flow of the writing process of FIG. 4, in the reading process, the kernel 221 inquires the LBA table to obtain a logical address corresponding to one or a plurality of specified storage spaces in the storage device 23, where the LBA table indicates that the video stream to be read has been written into the one or a plurality of the specified storage spaces in the storage device 23 corresponding to the logical address. Then, the kernel 221 obtains the specified identifier corresponding to the specified storage space in the storage device 23 that stores the video stream according to the logical address, and searches the specified storage space in the storage device 23 that stores the video stream according to the specified identifier. Moreover, after the specified storage space corresponding to the specified identifier is found, the kernel 221 directly reads the video stream from the specified storage space in the storage device 23.

In this way, in the present embodiment, the digital video converter 20 can also be coupled to the display device 24, so as to play the video stream through the display device 24. Moreover, the processing device 22 can also display a user operation interface on the display device 24, and displays a video file name corresponding to the video stream stored in the storage device 23 on the user operation interface. Moreover, the processing device 22 determines whether the video file name displayed on the user operation interface is selected. When the video file name is selected, the processing device 22 executes the reading process to play the video stream corresponding to the selected video file name.

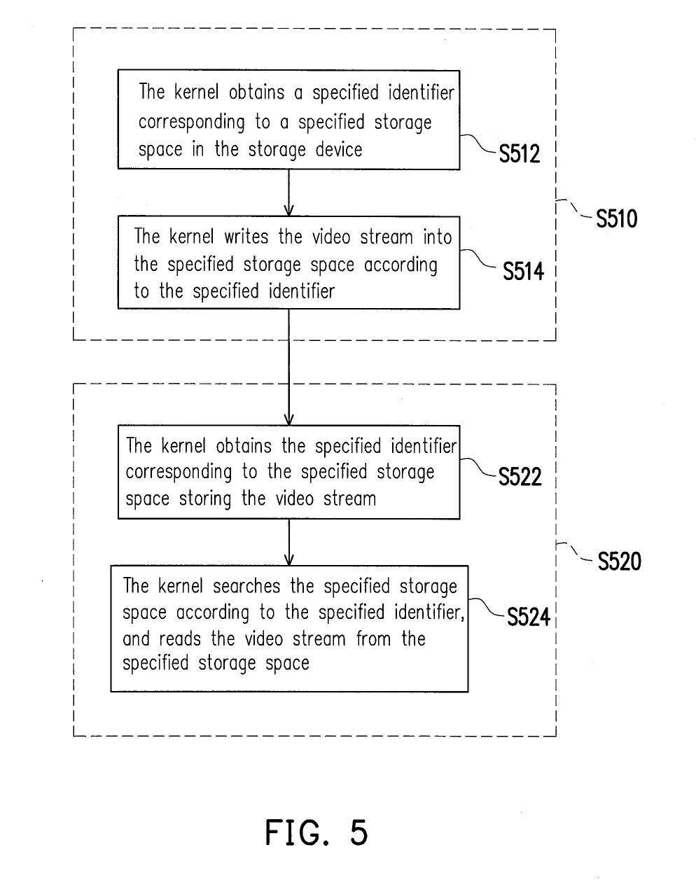

FIG. 5 is a flowchart illustrating a method for reading and writing a video stream according to an embodiment of the invention.

Referring to FIG. 5, in step S510, an operating system of a digital video converter executes a writing process to write a video stream to a storage device of the digital video converter according to a data storage request of a user, where the digital video converter includes the operating system and the storage device divided into a plurality of storage spaces, and the operating system is configured with a kernel and a user space. In detail, the writing process of the step S510 includes following steps. In step S512, the kernel of the operating system obtains a specified identifier corresponding to a specified storage space in the storage device according to the data storage request of the user. Then, in step S514, the kernel of the operating system writes the video stream into the specified storage space according to the specified identifier.

Moreover, in step S520, the operating system of the digital video converter executes a reading process to read the video stream from the storage device of the digital video converter according a data reading request of the user, where the reading process of the step S520 includes following steps. In step S522, the kernel of the operating system obtains the specified identifier corresponding to the specified storage space storing the video stream according to the data reading request of the user. Then, in step S524, the kernel of the operating system searches the specified storage space storing the video stream according to the obtained specified identifier, and reads the video stream from the specified storage space. Particularly, neither of the writing process of the step S510 and the reading process of the step S520 involves the user space of the user space.

Moreover, the step S510 and the step S520 can be respectively executed according to the read operation and write operation performed on the video stream by the digital video converter.

It should be noticed that since those skilled in the art can learn enough instructions, recommendations and descriptions from the aforementioned embodiment for the aforementioned method, detailed description thereof is not repeated.

In summary, the invention provides the digital video converter and the method for reading and writing a video stream, by which the kernel can be used to directly read data from the storage device and write data to the storage device in case that the user space of the operating system is not involved. In this way, the performance that the digital video converter performs the read or write operation on the video stream can be effectively enhanced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A digital video converter, comprising:
a processing device, running an operating system, wherein the operating system is configured with a kernel and a user space; and
a storage device, coupled to the processing device,
wherein the processing device executes a writing process to write a video stream to the storage device according to a data storage request of a user,
when the processing device executes the writing process, the kernel obtains a specified identifier corresponding to a specified storage space in the storage device according to the data storage request of the user, and writes the video stream into the specified storage space according to the specified identifier,
wherein the processing device executes a reading process to read the video stream from the storage device according a data reading request of the user,
when the processing device executes the reading process, the kernel obtains the specified identifier corresponding to the specified storage space storing the video stream, and searches the specified storage space according to the specified identifier, and reads the video stream from the specified storage space,
wherein the writing process and the reading process do not involve the user space.

2. The digital video converter as claimed in claim 1, wherein the kernel inquires a logical block address table to obtain a logical address corresponding to the specified storage space, wherein the logical block address table indicates that the specified storage space corresponding to the logical address is capable of being written with data,
wherein the kernel obtains the specified identifier corresponding to the specified storage space according to the logical address, searches the specified storage space according to the specified identifier, and writes the video stream into the specified storage space.

3. The digital video converter as claimed in claim 1, wherein the kernel inquires a logical block address table to obtain a logical address corresponding to the specified storage space, wherein the logical block address table indicates that the video stream has been written into the specified storage space corresponding to the logical address,
wherein the kernel obtains the specified identifier corresponding to the specified storage space according to the logical address, searches the specified storage space according to the specified identifier, and reads the video stream from the specified storage space.

4. The digital video converter as claimed in claim 1, further comprising:
a video stream receiving device, coupled to the processing device, and generates the video stream according to a television signal.

5. The digital video converter as claimed in claim 1, wherein the processing device displays a user operation interface in a display device,
wherein the user operation interface displays a video file name corresponding to the video stream,
wherein the processing device determines whether the video file name is selected,
when the video file name is selected, the processing device executes the reading process to play the video stream.

6. A method for reading and writing a video stream, adapted to a digital video converter, the method for reading and writing the video stream comprising:
executing a writing process to write a video stream to a storage device of the digital video converter according to a data storage request of a user, wherein the digital video converter comprises an operating system and a storage device having a plurality of storage spaces, the operating system is configured with a kernel and a user space, and the writing process comprises:
obtaining a specified identifier corresponding to a specified storage space in the storage device by the kernel according to the data storage request of the user; and
writing the video stream into the specified storage space by the kernel according to the specified identifier; and
executing a reading process to read the video stream from the storage device according to a data reading request of the user, wherein the reading process comprises:
obtaining the specified identifier corresponding to the specified storage space storing the video stream by the kernel; and
searching the specified storage space by the kernel according to the specified identifier, and reading the video stream from the specified storage space,
wherein the writing process and the reading process do not involve the user space.

7. The method for reading and writing the video stream as claimed in claim 6, wherein the writing process comprises:
inquiring a logical block address table by the kernel to obtain a logical address corresponding to the specified storage space, wherein the logical block address table indicates that the specified storage space corresponding to the logical address is capable of being written with data;
obtaining the specified identifier corresponding to the specified storage space by the kernel according to the logical address; and
searching the specified storage space by the kernel according to the specified identifier, and writing the video stream into the specified storage space.

8. The method for reading and writing the video stream as claimed in claim 6, wherein the reading process comprises:
inquiring a logical block address table by the kernel to obtain a logical address corresponding to the specified storage space, wherein the logical block address table indicates that the video stream has been written into the specified storage space corresponding to the logical address;
obtaining the specified identifier corresponding to the specified storage space by the kernel according to the logical address; and
searching the specified storage space by the kernel according to the specified identifier, and reading the video stream from the specified storage space.

9. The method for reading and writing the video stream as claimed in claim 6, wherein the video stream is obtained through a television signal.

10. The method for reading and writing the video stream as claimed in claim 6, further comprising:
displaying a user operation interface;
displaying a video file name corresponding to the video stream on the user operation interface;
determining whether the video file name is selected; and
executing the reading process to play the video stream when the video file name is selected.
